(19) United States
(12) Patent Application Publication
(10) Pub. No.: US 2020/0275817 A1
(43) Pub. Date: Sep. 3, 2020

(54) CLEANING APPARATUS AND METHOD FOR OPERATING A CLEANING APPARATUS

(71) Applicant: Enway GmbH, Berlin (DE)

(72) Inventors: Julian NORDT, Berlin (DE); Thanuja AMBEGODA, Berlin (DE); Bo CHEN, Berlin (DE)

(21) Appl. No.: 16/764,144

(22) PCT Filed: Dec. 18, 2018
(86) PCT No.: PCT/EP2018/085677

§ 371 Date: May 14, 2020

(30) Foreign Application Priority Data
Dec. 21, 2017 (DE) 10 2017 130 954.3

(51) Int. Cl. A47L 11/40; A47L 11/24

(52) U.S. Cl. CPC A47L 11/4011; A47L 9/2826; A47L 11/4061; A47L 11/24

(57) ABSTRACT

The invention relates to a cleaning device having a receiving device for receiving objects to be cleaned, a drive device for moving the cleaning device, a control device for controlling the drive device for steering a movement of the cleaning device as a function of sensor signals provided by a sensor system, a detection unit for detecting objects to be cleaned arranged in a predefinable area, an evaluation unit for classifying the objects to be cleaned detected by the detection unit into various contamination classes, and a track planning unit for determining an optimized track for the cleaning device in the predefined area as a function of a particular position of the objects to be cleaned detected and the particular contamination class of the object to be cleaned, wherein the control device is configured to control the drive device to perform a cleaning pass along the optimized track determined.

The present invention relates to a cleaning apparatus and a method for operating a cleaning apparatus.

Cleaning apparatuses are well-known which perform a specific cleaning operation on their own, such as suction robots or wipe robots. For example, these are deployed in the private area for cleaning apartments. Such a suction robot can be configured to determine its way by itself. Thereby, at conventional suction robots, a target is that the suction robot covers the entire surface of the area, in which it is used, in one cleaning ride. This can be achieved in different manners. For example, such approaches for track determination of the suction robot are referred to as area-optimized track determination methods.

For example, at very large areas, as they appear in the public space at public places, at such a determined area-optimized track, the problem occurs that the path length of the track can be very long. Thus, the cleaning apparatus requires a very long time in order to drive the entire track and to clean the area.

DE 10 2013 113 426 A1, DE 10 2014 110 265 A1 as well as DE 20 2015 103 904 describe well-known cleaning apparatuses.

Against this background, an object of the present invention is to propose an improved cleaning apparatus.

According to a first aspect, a cleaning apparatus having a housing device for housing dirty objects, a drive device for moving the cleaning apparatus, a control device for controlling the drive device for steering of a movement of the cleaning apparatus in dependence on sensor signals provided by a sensor system is proposed. The cleaning apparatus comprises a detection unit for detecting dirty objects arranged in a predefinable area, an evaluation unit for classifying the dirty objects detected by the detection unit into different dirty classes, and a track planning unit for determining an optimized track for the cleaning apparatus in the predefined area in dependence on a respective position of the detected dirty objects and the respective dirty class of the dirty objects, wherein the control device is configured to control the drive device for performing a cleaning ride along the determined optimized track.

The cleaning apparatus has the advantage that it determines an optimal or optimized track for cleaning the predefined area in dependence on predefinable parameters and removes the dirty objects along the optimal and/or optimized track. In particular, the cleaning apparatus requires for this purpose less time and/or achieves an improved cleaning result with respect to the predefined area as a conventional cleaning apparatus. Thus, this cleaning apparatus is in particular suitable for increasing an efficiency at the cleaning of a predefinable area and therefore to effectively reduce operating costs and/or maintenance costs.

In particular, a cleaning apparatus can herein be understood as a machine which at least comprises a tool with which it is capable to pick up a dirty object and/or to remove it from a surface to be cleaned in an otherwise manner. For example, the tool can be formed as a brush, in particular as a round brush with a drive. The cleaning apparatus can have further tools which are suitable for cleaning a surface, such as a nozzle arrangement for the exposure of the surface with a liquid and/or a suction apparatus.

A dirty object can herein be understood as any kind of dirt. In particular, this can comprise rubbish, trash, dust, crud and/or organic material. In the following, the dirty object can be referred to as dirt and/or filth. Thereby, the dirt can be present in solid form and/or in liquid form. For example, an object commonly not perceived as filth or dirt can be considered as dirty object.

For example, the housing device for housing dirty objects is formed as a housing room, a housing container and/or a supply device for supplying dirty objects to a removable and/or interchangeable housing container. For example, such a housing container is formed as a liquid-tight container which can house a specific volume of filth. For example, it can be provided that the housing room or the housing container has a separation device for separating liquid constituted elements from solid constituted elements. Furthermore, separated housing containers can be provided for the respective constituted elements. Further, a compression device can be provided which compresses the housed filth and thus effectively increases the housing capacity of the housing container.

For example, a drive device can herein be understood as a rack mounted on wheels, such as a car body, wherein for example motors, in particular electromotors, are provided in order to drive at least one of the wheels. For example, the rack has a triangular basic form, wherein at each of the three corners a wheel is mounted. Thereby, at least one of the wheels is driven and is mounted orientably and can be oriented by means of a motor for steering of a movement of the rack and consequently of the cleaning apparatus. For example, the both further wheels are formed as support wheels and cannot be moved or driven. Thereby, a lot of further embodiments are thinkable.

In particular, the control device is the central control device for the cleaning apparatus which controls and/or coordinates all substantial functions of the cleaning apparatus. For example, coordinating can be understood that in addition to the control device further devices, such as device-specific control units, can be provided which execute a controlling of a respective device in dependence on the control device. The control device may be implemented in hardware and/or also in software. If the control device is implemented in hardware, it may be embodied as a computer or as a microprocessor. If the control device is implemented in software, it may be embodied as a computer program product, as a function, as a routine, as a part of a program code or as an executable object.

In particular, the control device is configured for steering of a movement of the cleaning apparatus. For example, this means that the control device controls the drive unit such that the drive unit accordingly converts the movement. The control device controls the drive unit in dependence on sensor signals which are provided by a sensor system of the cleaning apparatus.

In particular, the sensor system comprises sensors which allow a detection of an environment of the cleaning apparatus. For example, these are ultrasound, infrared, image and/or tactile sensors. In particular, an ultrasound sensor is suitable for detecting a distance to an object. An infrared sensor is particularly suitable for detecting heat dissipating objects such as humans and/or animals. For example, the sensor system also detects data of the drive device, such as a position and/or a rotation number of single wheels, further environment data or ecological data, such as an outside temperature, a wind direction, a wind speed as well as a condition of the surface on which the cleaning apparatus is moved. For example, the condition of the surface can be understood as a type of the surface, such as asphalt, concrete, plaster, tile, carpet, grass and/or soil, and/or the quality of the surface, such as wet, dry, soft and/or hard. In particular, the sensor system comprises also a position sensor which allows a detecting of an absolute position, such as a GPS sensor, a Galileo sensor and/or a Glonass sensor.

The sensor system provides a sensor signal of a respective sensor to the control device. The control device is configured to control the drive device in dependence on that sensor signal or the sensor signals. This can comprise a processing, an analyzing and/or an evaluating of the sensor signals. For example, the control device can perform an image processing of a camera image, in particular of an image flow, and can recognize moving objects. Here, a plurality of signal analyses is thinkable. In particular, the control device is configured to analyze each of the sensor signals according to a suitable signal analysis.

In particular, with the sensor system, the control device can be configured for autonomous controlling of the cleaning apparatus. Thereby, also security aspects are in the foreground and are accordingly taken into account so that, at an autonomous operation of the cleaning apparatus, no living things gets injured and also no otherwise things, such as cars, get damaged.

The detection unit for detecting dirty objects arranged in a predefinable area, the evaluation unit for classifying dirty objects detected by the detection unit into different dirty classes and/or the track planning unit for determining an optimized track may be implemented in hardware and/or also in software. If said unit is implemented in hardware, it may be embodied as a computer or as a microprocessor. If said unit is implemented in software, it may be embodied as a computer program product, as a function, as a routine, as a part of a program code or as an executable object. In particular, said respective unit can be implemented as a part of the control device.

In particular, the detection unit can evaluate the sensor signals provided by the sensor system for detecting dirty objects. This is particularly advantageous since the sensor system therefore fulfills a double function that means it is used on the one hand for controlling the drive device and on the other hand for detecting dirty objects. Thus, a number of sensors can be reduced. The detection unit is configured to detect dirty objects in a predefinable area. For example, the predefinable area can comprise a total area to be cleaned. For example, the predefined area can be defined by coordinates, wherein respective coordinates define, for example, corner points of a polygon on a map which are to be connected by straight lines, wherein the enclosed area is the predefinable area. The predefinable area can also be dynamically updateable, either by the cleaning apparatus itself, for example if a part area of the predefined area is detected as non-accessible or even from the outside in which a predefined area is changed. For example, the predefinable area can be defined as a path in a town, wherein, for example, the therefore predefined area comprises a corridor with a width of 10 m along the path.

Advantageously, the detection unit dynamically detects dirty objects in the predefinable area. Therefore, it is possible to detect a new dirty object at any time, and it can respectively be taken into account in the sequence. This is advantageous if a predefined area cannot be entirely detected by the sensor system, because part areas of the area are located outside of a detection area of single sensors. When the cleaning apparatus is moving and by that these part areas are now detectable, also the herein included dirty objects can be detected.

For example, the detection unit is configured to detect a dirty object based on its outer appearance. For example, the outer appearance thereby comprises dimensions, a geometry, a color and/or a surface structure of the dirty object.

The evaluation unit for classifying the dirty objects, detected by the detection unit, into different classes is in particular configured to analyze the detected properties of the detected dirty object. In particular, these properties comprise the outer appearance as well as further properties, such as hard, soft, liquid, solid, sticky and/or adherent. Further, additional sensors which possibly are specifically assigned to the evaluation unit can be provided, such as fragrance sensors and/or further chemical sensors. Thereby, the evaluation unit can take into account the sensor signals detected by these sensors at the classification.

Thereby, the classification is performed for example in dependence on predetermined parameter values and/or parameter areas for a respective sensor signal or a result of an analysis of a respective sensor signal. In particular, these parameter values and/or parameter areas can be fixedly predefined, they can be dynamically detectable and detectable in dependence on the situation by the evaluation unit or the control device and/or they can be fed in over a communication channel. Various dirty classes differ from each other, for example by the type of dirt. For example, for leaves, for rubbish, such as roll split, filth, cigarette ends or other small garbage, for organic material, such as excrements, for liquids and/or for larger objects, one respective dirty class can be provided.

In the following, an example for a dynamical fitting is described. For example, the cleaning apparatus has a certain liquid stock for the operation of a high-pressure cleaner. After the cleaning apparatus has handled a number of dirty objects with the high-pressure cleaner, the liquid stock is exhausted. After that, the cleaning apparatus can no longer use the high-pressure cleaner for handling of dirt. Dirty objects which need a handling with a high-pressure cleaner are thus from now on excluded from the handling, until the liquid stock is recharged. For example, the cleaning apparatus can transmit a respective signal to a control center that signalizes that the liquid stock of the cleaning apparatus is exhausted, and as a result, a service employee frequents the cleaning apparatus and recharges the liquid storage again.

The classifying can be referred to as rating, ranking, categorizing, evaluating and/or judging. A dirty class can be referred to as a filth category or a filth order. A priority or an importance can particularly be assigned to a respective dirty class which sets how important the removal of filth of the respective class is. In particular, this can individually be determined by an operator of the cleaning apparatus.

The track planning unit is configured for determining an optimized track for the cleaning apparatus in the predefined area in dependence on a respective position of the detected dirty objects and the respective dirty class of the dirty objects. In particular, an optimized track can be understood as that the track is optimized by taking into account the dirty classes of dirty objects and/or a time effort. Thereby, defaults for optimization can be individually adjustable.

For example, it can be provided that a dog excrement is removed with a higher priority, because dog excrements are perceived by a human as particularly strong dirt. Further, also the size of a dirty object or also the amount at an accumulation of smaller dirty objects, such as cigarette ends, can be taken into account at the optimization. Further, positions of dirty objects are taken into account at the optimization. In particular, relative positions are determined, for example. In this manner, it is particularly easy to detect which dirty objects are close to each other and can be connected with comparatively short path lengths on a cleaning ride. One example for the track optimization is a solution of the “travelling salesman problem” known as an optimization problem, possibly firstly without taking into account of dirty classes of the dirty objects.

Occasionally, the dirty classes represent weights for the various dirty objects which are taken into account at the solution of the optimization problem. For example, this can lead to that the optimized track firstly provides a longer path length for one especially important rated dirty object, wherein smaller, closer located dirty objects are not firstly driven to.

The control device is configured to control the drive device for performing a cleaning ride along the determined optimized track. For this purpose, the track planning unit transfers the determined optimized track to the control device, whereas the control device sets the cleaning apparatus into motion by means of the drive device. As soon as a dirty object along the track is reached, the dirty object is handled by the cleaning apparatus, preferably it is picked up and removed from the surface. Thereby, it can be provided that the control device is configured to control and to activate a tool for handling the dirty objects only at an arrival at the dirty object. This can save energy and can contribute to reduce emissions by the cleaning apparatus.

Thus, the cleaning apparatus is capable to remove dirt within the predefinable area along an optimized track which takes a weight of the filth into account and therefore to make an efficient cleaning of the predefinable area possible. Thereby, the cleaning apparatus can particularly reduce a time effort for cleaning and can particularly preferably handle serious dirt such that an overall impression of the area that is subjectively tidy and/or clean for a human can be achieved particularly fast, also if in the meantime further dirty objects remain in the area. Furthermore, the cleaning apparatus can be configured for autonomous operation, whereby a monitoring effort by humans can be reduced. A further advantage is that the cleaning apparatus can reduce emissions, in particular noise and/or dust, by selective use of specialized cleaning tools.

According to an embodiment of the cleaning apparatus, the detection unit is configured to assign to each detected dirty object a dirty object vector which comprises the position of the detected dirty object, a type of the detected dirty object and/or an amount of the detected dirty object.

For example, a type of a dirty object is defined by the kind of the dirty object. Furthermore, the type can comprise, as described above, various properties of the dirty object. For example, an amount of the dirty object can comprise a number, a volume and/or a distribution of the dirty object.

According to a further embodiment of the cleaning apparatus, the evaluation unit is configured to classify a detected dirty object in dependence on the assigned dirty object vector.

In particular, the dirty object vector comprises all information which is relevant for the classifying. Therefore, this is advantageous because the dirty object vector represents a uniform data format. Starting from this uniform data format, further method steps can efficiently be implemented.

According to a further embodiment of the cleaning apparatus, the detection unit comprises a field device which can be decoupled from the cleaning apparatus and a receiving unit, wherein the field device is configured for detecting at least one of the dirty objects and for transmitting an indicative information for the detected dirty object to the receiving unit.

For example, the field device can be formed as a hand device with a sensor device, for example an image sensor, a chemical sensor and/or a positioning sensor. It can be provided that a foreman controls the hand device. For example, the foreman takes the hand device up from the cleaning apparatus and starts with marking dirty objects in a specific area. By doing so, the foreman goes to the dirty object and actuates an input button on the hand device, for example. It can be provided that the foreman detects a sensor signal of the dirty object by means of the sensor device. In particular, by means of the positioning sensor, the position of a respective dirty object is detected. In particular, the position can thereby be detected relative to the cleaning apparatus, that means as a distance or a direction. The information of the respective dirty object detected in this way is transmitted to the receiving unit at the cleaning apparatus in the format of an indicative information. This is carried out particularly wireless, for example by WLAN, Bluetooth®, infrared, Zigbee®, ANT® and/or ANT+®. In particular, the data transmission can also be implemented cryptographically secured.

For example, it can be provided that the indicative information has the format of the dirty object vector and is transmitted as one or more data packets.

In embodiments, it can be provided that the hand device has an interface for inputting a dirty class. Then, the worker which operates the hand device can already manually take a preselection for the dirty class of a respective dirty object. The evaluation unit can be configured to accept this preselection or alternatively to not accept this preselection, because, for example, an erroneous classifying by the worker has appeared. For example, the evaluation unit can detect this in dependence on sensor signals of a dirty object.

Further, in embodiments, it can be provided that the field device is formed as an autonomous device such as a robot. This robot can be sent out from the cleaning apparatus like a drone in order to, for example, analyze an area for dirty objects which is predetermined by the cleaning apparatus. Hereby, the robot can have various sensors which detect a respective dirty object. In particular, the cleaning apparatus can also have multiple of these robots. In particular, a flight drone, for example a quadcopter, can be provided which can detect the predefinable area from the air at a mission in the free space.

According to a further embodiment of the cleaning apparatus, the cleaning apparatus has a plurality of tools for handling dirty objects which are selectively controllable by the control device, wherein a respective tool is optimized for handling dirty objects of a specific dirty class.

For example, a tool is a functional arrangement of components which are suitable for handling the surface to be cleaned. In particular, the tool can have a mechanical, a physical and/or a chemical cleaning effect. An example for a mechanical acting tool is a brush. An example for a physical acting tool is a suction device. A further example for this is a radiation device for radiating the surface with electromagnetic radiation, for example heat radiation, microwave radiation and/or UV radiation. An example of a chemical acting handling is an applying of a cleaning means and/or a solvent. Tools can also have a combined effect such as a high-pressure cleaner which operates with heated water. Thereby, a mechanical cleaning effect results by the pressure of the water on the surface or on the dirty object, a physical cleaning effect by the heat applying in the dirty object and a chemical cleaning effect by the solvent effect of the water.

In particular, the control device is configured to use the tools according to its individual suitability for handling of filth of a dirty class. For example, for picking up loose rubbish and leaves, a brush in combination with a suction device can be controlled. For example, for handling sessile filth, a high-pressure cleaner in combination with a wet suction device can be controlled. At a handling of a dirty object hygienically questionable, a disinfecting agent can be applied in advance, during and/or after the handling. For example, this can comprise a radiating with UV light and the deployment of a liquid or gas-like chemical.

According to a further embodiment of the cleaning apparatus, the control device is configured, when the cleaning apparatus reaches a dirty object, to control, in dependence on the dirty class of the reached dirty object, that tool which is optimized for this dirty class for handling the dirty object.

In this manner, an optimized cleaning or handling result can be achieved. For example, a brush is not suitable for picking up a liquid dirty object why for this purpose in particular a wet suction device is controlled.

According to a further embodiment of the cleaning apparatus, the track planning unit is configured to dynamically update the optimized track in dependence on time-varying conditions.

The time-varying conditions particularly comprise positions of the dirty objects, a change of the dirty objects according to their number, their classification and/or also time-varying obstacles for the cleaning apparatus such as moving humans, animals and/or cars in the predefined area.

In particular, at the approaching of the cleaning apparatus to a dirty object, the dirty class of the dirty object can be changed, because an analysis capability at short distance can be improved.

According to a further embodiment of the cleaning apparatus, the cleaning apparatus has a verification unit which is configured, after the handling of a dirty object, to determine a success of the handling of the dirty object in dependence on a removal of the dirty object.

In particular, the verification unit comprises that sensors of the sensor system which are suitable for detecting the dirty objects. The verification unit is configured for determining the success of the handling of a dirty object. For example, if the verification unit can detect a dirty object no longer on the position after the handling, the handling was successful. In particular at areal dirt, such as roll split or leaves, also a specific threshold value can be predefined, above which a handling applies as success. For example, it can be determined that the handling was successful at a removal of at least 90% of an output amount of a dirty object. In particular, a removal can be understood as picking up the dirty object with the housing device of the cleaning apparatus.

According to a further embodiment of the cleaning apparatus, the control device is configured to handle the dirty object again in dependence on the success of the handling.

For example, the control device controls the drive unit for this such that the cleaning apparatus is steered again over the position of the dirty object, wherein the tool, which is suitable for the respective dirty class, is selectively controlled again. It can also be provided that an additional or an alternative tool is controlled. This can especially be helpful at dirty objects which comprise various filth classes. For example, in a first round, loose parts of the dirty object can be picked up. In a second round, a sessile part of the dirty object can first be shortly dissolved by means of a solvent and can then be detached from the surface by means of a high-pressure cleaner and can be picked up by a suction device.

According to a further embodiment of the cleaning apparatus, the track planning unit is configured to integrate multiple dirty objects into one group of dirty objects and to determine the optimized track in dependence on the group.

In particular, at small dirty objects such as cigarette ends which are distributed close to a garbage can or an ashtray, such an integrating can be efficient. For example, the group is assigned to a group vector which is detected, for example, as a superposition of the single dirty object vectors of the dirty objects of the group. In this manner, a calculating effort can be reduced because in summary a smaller number of dirty objects has been taken into account. Furthermore, by doing this, it can also be avoided that smaller dirty objects are not taken into account because they are of comparatively low importance in their own, but the group as a whole is important.

According to a further embodiment of the cleaning apparatus, the cleaning apparatus is configured to autonomous cleaning of the predefinable area.

For example, the cleaning apparatus can be formed fully autonomous or partly autonomous. For example, fully autonomous can be understood that the cleaning apparatus is placed in a predefined area, is started and then fully automatically begins to clean the predefined area. For example, partly autonomous can be understood that the cleaning apparatus is assigned to a worker which marks dirty objects in the predefined area and/or integrates distributed present dirty objects, in particular leaves, with a broom into groups, wherein the cleaning apparatus follows the worker along an optimized track and automatically receives the dirty objects.

According to a further embodiment of the cleaning apparatus, the cleaning apparatus is a cleaning robot, a road cleaning machine, a sweeping machine or a surface handling machine.

According to a second aspect, a method for operating a cleaning apparatus is proposed. The cleaning apparatus comprises a housing device for housing dirty objects, a drive device for moving the cleaning apparatus and a control device for controlling the drive device for steering of a movement of the cleaning apparatus in dependence on sensor signals provided by a sensor system. In a first step, dirty objects arranged in a predefined area are detected by a detection unit. In a second step, each detected dirty object is classified into a dirty class of a number of different dirty classes. In a third step, an optimized track is determined in dependence on a respective position of the detected dirty objects and the respective dirty class of the dirty objects. In a fourth step, a cleaning ride of the cleaning apparatus is performed along the determined optimized track by the control device.

In particular, the method has the advantage that the cleaning apparatus can perform a fast and efficient cleaning of a predefined area.

The embodiments and features described with reference to the apparatus apply mutatis mutandis to the method.

Furthermore, a computer program product is proposed, which initiates the execution of the above-mentioned method on a program-controlled apparatus.

A computer program product, such as a computer program means, may be provided or delivered as a memory card, USB stick, CD-ROM, DVD or also as a file which may be downloaded from a server in a network. For example, in a wireless communication network, this can be done by transferring a corresponding file using the computer program product or the computer program means.

Further possible implementations of the present invention also comprise not explicitly mentioned combinations of features or embodiments described above or below with regard to the embodiments. Thereby, the skilled person may also add isolated aspects as improvements or additions to the respective basic form of the present invention.

Further advantageous embodiments and aspects of the present invention are subject-matter of the dependent claims as well as the below described embodiments of the present invention. Furthermore, with reference to the attached drawings, the present invention is discussed in more detail on the basis of preferred embodiments.

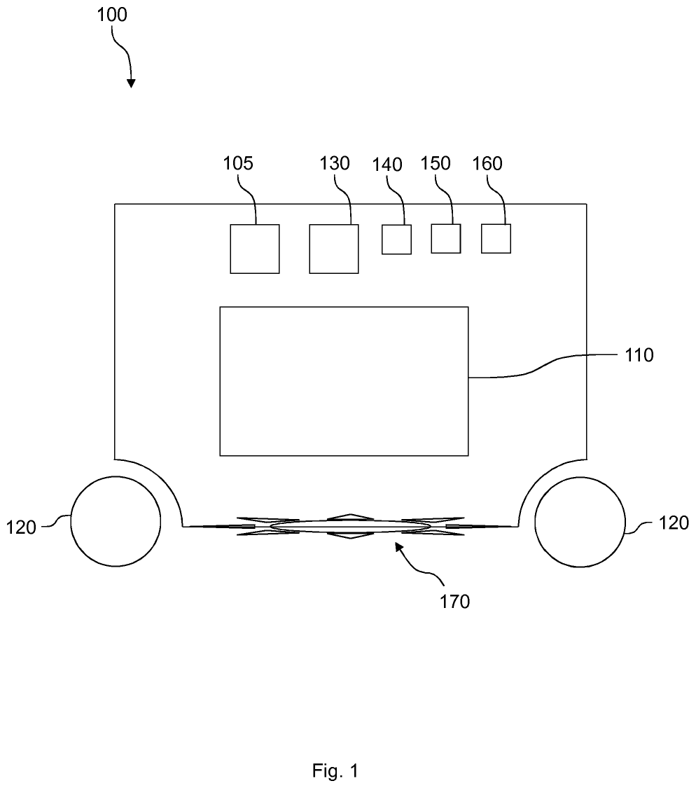

FIG. 1 shows a schematic side view of an embodiment of a cleaning apparatus;

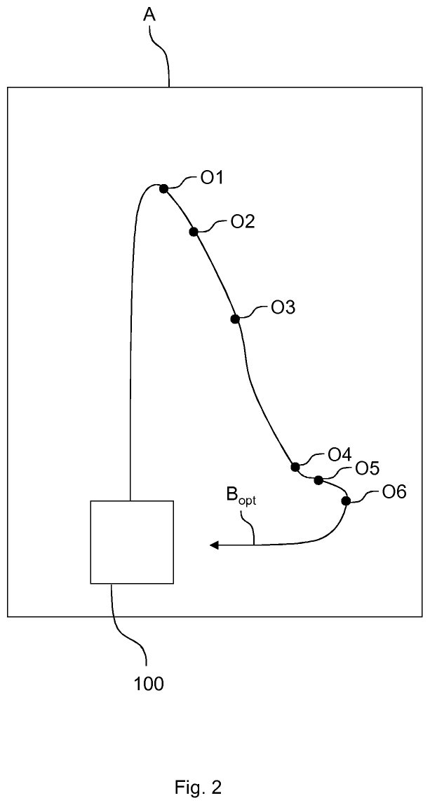

FIG. 2 schematically shows a first embodiment for a cleaning ride along an optimized track;

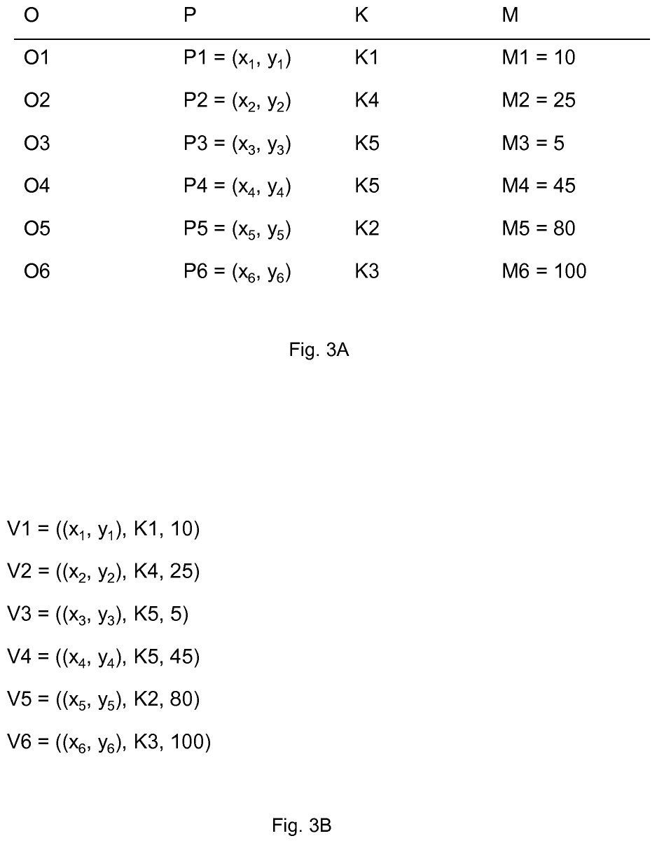

FIG. 3A shows an embodiment of a list of classified dirty objects;

FIG. 3B shows a first embodiment of a list of dirty object vectors;

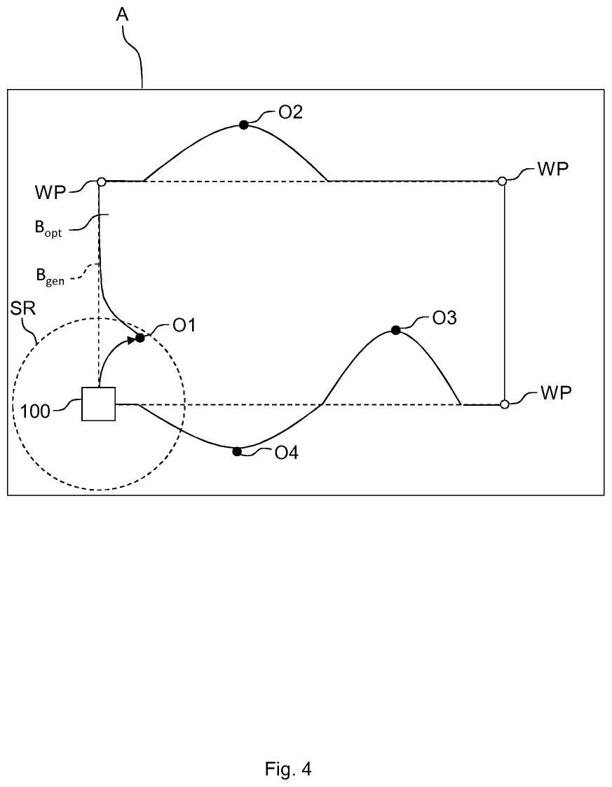

FIG. 4 shows a second embodiment for a cleaning ride along an optimized track;

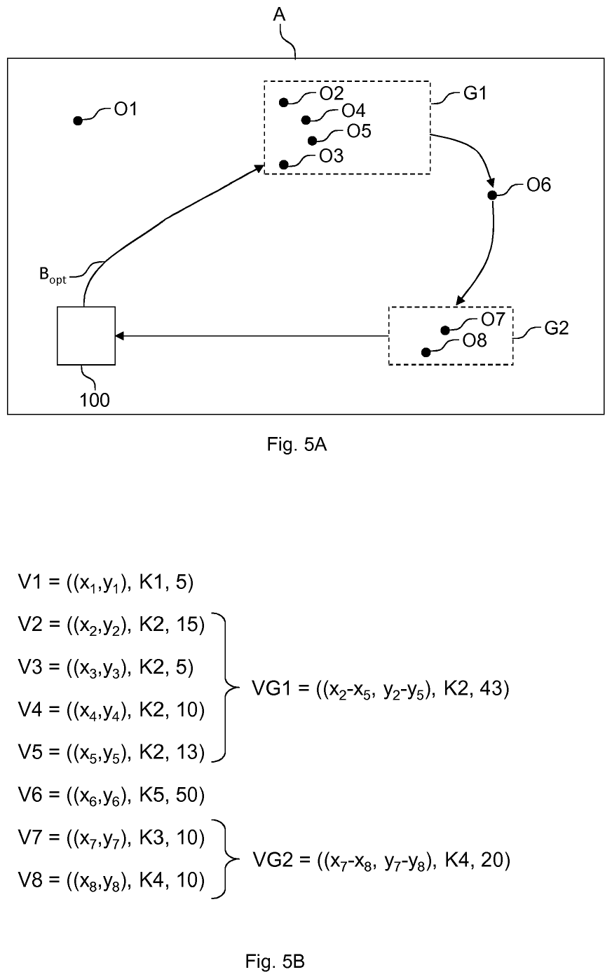

FIG. 5A shows a third embodiment for a cleaning ride along an optimized track;

FIG. 5B shows a second embodiment of a list of dirty object vectors;

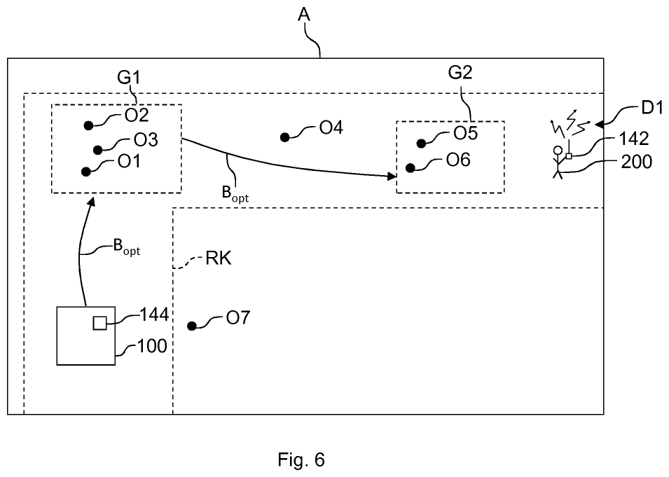

FIG. 6 shows a fourth embodiment of a cleaning ride along an optimized track; and

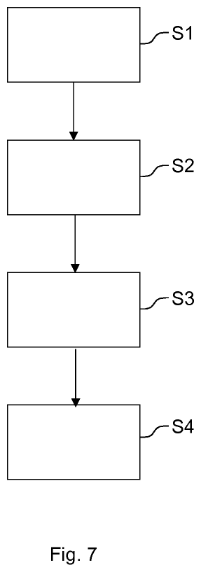

FIG. 7 shows a schematic block diagram of an embodiment for a method for operating a cleaning apparatus.

In the Figures, the same or functionally identical elements have been given the same reference numerals, unless otherwise indicated.

FIG. 1 shows a schematic side view of an embodiment of a cleaning apparatus 100 which is here formed as a sweeping machine. The sweeping machine 100 is formed as an autonomous electrical vehicle and has two drive devices 120 which are formed as steerable wheels driven by electromotors (not shown). The sweeping machine 100 has a housing device 110 which is formed as a housing room for housing of sweepings. Alternatively, the housing device 110 could be formed as a supply device, wherein, for example, a roll container is coupled to the cleaning apparatus 100 in which dirty objects O are supplied (not shown). Furthermore, the sweeping machine has a sensor system 105 which comprises a number of different sensors which are here not shown in single. The sensors of the sensor system 105 comprise a visual camera on each side of the sweeping machine 100, radar distance sensors which are uniformly arranged along a periphery of the sweeping machine 100, in addition infrared cameras as well as a GPS module for detecting an absolute position of the sweeping machine 100. The sensor system 105 detects a sensor signal from every of these sensors and outputs this, if it desired, in a processed and/or preprocessed format to the control device 130.

The sweeping machine 100 is controlled by a control device 130 implemented as a microprocessor. The microprocessor 130 is configured to detect the sensor signal from the sensor system 105 and to process and/or to analyze this sensor signal. In particular, a processing comprises an image processing, a signal analysis, a pattern recognition and/or a frequency analysis of the sensor signal or the sensor signals. For this purpose, the microprocessor 130 can also have a neural network. In particular, the microprocessor 130 controls the drive device 120 such that the sweeping machine 100 moves along a path which is determined in advance, in particular an optimized track Bₒₚₜ (see, for example, FIGS. 2, 4, 5A and 6).

The sweeping machine 100 further has a detection unit 140, an evaluation unit 150 and a track planning unit 160. These units 140, 150, 160 are represented here separately, but can also be part of the control device 100.

For example, the detection unit 140 is configured to detect dirty objects O (see, for example, FIGS. 2, 4, 5A and 6) in a predefined area A in dependence on sensor signals of the sensor system 105 as well as from further not shown sensors.

The evaluation unit 150 is configured to classify the detected dirty objects O into dirty classes K (see, for example, FIG. 3A, 3B, 5A, 5B). Thereby, a dirty object O is preferably assigned to exactly one dirty class K.

In particular, the detection unit 140 as well as the evaluation unit 150 are formed as a neuronal network.

The track planning unit 160 is configured to determine an optimized track Bₒₚₜ for cleaning the predefined area A. In particular, this is carried out in dependence on properties of the dirty objects O, in particular of their respective position P and dirty class K.

The sweeping machine 100 has a tool 170 on its bottom side that is here formed as a sweeping device 170. The sweeping device 170 is configured to carry loose filth, rubbish and sweepings from a surface under the sweeping machine 100 into the housing room 110. The sweeping machine 100 can further comprise further tools 170 which are not shown here.

FIG. 2 schematically shows a first embodiment for a cleaning ride along an optimized track Bₒₚₜ within a predefined area A. In this example, the cleaning apparatus 100 is schematically shown without any further details. For example, in this case it can be the sweeping machine 100 which is shown in FIG. 1.

The cleaning apparatus 100 is arranged in a left bottom corner of the predefined area A. For example, the predefined area A is a part area of a public space for which to clean the cleaning apparatus 100 has been started. In the predefined area A, there are six dirty objects O1-06.

In this example, the cleaning apparatus 100 detects the entire predefined area A at once. It can be said that the cleaning apparatus 100 scans the predefined area A. Thereby, the detection unit 140 (see FIG. 1) detects the six dirty objects O1-O6. The evaluation unit 150 classifies the detected dirty objects O1-O6 into dirty classes K (see FIG. 3A, 3B). Herein, it is paper waste, for example. Therefore, the six dirty objects O1-O6 are all assigned to the same dirty class K (not shown). The track planning unit 160 determines an optimized track Bₒₚₜ now along which the cleaning apparatus 100 can remove the six dirty objects O1-O6 as efficient as possible.

Thereby, the optimized track Bₒₚₜ comprises all six dirty objects O1-O6 and connects these with an ideally short path. This optimized track Bₒₚₜ is optimized in such a way that a time period which is necessary for the cleaning apparatus 100 for cleaning the predefined area A is reduced compared to an area-optimized track (not shown) which would detect the entire predefined area A. The optimized track Bₒₚₜ for the cleaning of the predefined area A has, for example, ca. 10-20% of the length of an area-optimized track for the predefined area A. Accordingly, the cleaning can be sooner finished. By doing this, further advantages compared to a conventional track planning method arise, for example emissions can be reduced, an energy consumption of the cleaning apparatus 100 can be reduced and a deterioration of tools 170 can also be reduced.

FIG. 3A shows an embodiment of a list of detected and classified dirty objects O1-O6 which is arranged in a table. The list comprises, for each of the detected dirty objects O1-O6, a position P which is here defined, for example, as a two-dimensional coordinate (x, y), an assigned dirty class K of a number of dirty classes K1-K5 as well as an individual amount M, M1-M6 which represents, for example, an approximate volume of the respective dirty object O1-O6.

FIG. 3B shows a first embodiment of a list of dirty objects V1-V6. For example, the list of dirty object vectors V1-V6 has been created, for example based on the table of the detected and classified dirty objects O1-O6 of FIG. 3A. Thereby, a dirty object vector V1-V6 has, as a first entry, the position P1-P6 of a respective dirty object O1-O6. For example, the position P1 of the first dirty object O1 consists of the coordinates (x₁, y₁). As a second entry, the dirty object vector V1-V6 includes the respective assigned dirty class K, for example for the first dirty object O1 the dirty class K1. As a third entry, the dirty object vector V1-V6 includes the respective amount M of dirt, wherein M1=10 for the first dirty object O1.

On the basis of their respective dirty object vector V1-V6, the dirty objects O1-O6 can be analyzed particularly easy and fast. For example, based on their individual positions P1-P6 of the dirty objects O1-O6, it is possible to detect their relative distances to each other and to integrate dirty objects O1-O6 which are close to each other into groups G1, G2 (see FIG. 5A, 6). For example, it is possible to further assign a weight to each of the dirty classes K, K1-K5, wherein, for example, a product of the weight with the respective amount of a dirty object O1-O6 results in a total weight for the respective dirty object O1-O6. For example, the total weight of a dirty object O1-O6 mirrors an importance or a priority with which the dirty object is taken into account in the track planning.

The exemplary structure of the dirty object vectors V1-V6, which is outlined here, is deliberately kept simple. In the application, a respective dirty object vector V1-V6 can have many more and/or more differentiated details of a respective dirty object O1-O6, and the processing of the dirty object vectors V1-V6 can be carried out in the context of the determination of an optimized track Bₒₚₜ in a complex manner.

FIG. 4 shows a second embodiment for a cleaning ride along an optimized track Bₒₚₜ. In this example, the sensors of the sensor system 105 for detecting dirty objects O1-O6 respectively have a limited detection area SR. In this example, the cleaning apparatus 100 is employed in a predefined area A which is substantially larger than the detection area SR.

The cleaning apparatus 100 firstly detects multiple way points WP in dependence on the detection area SR and the predefined area A which are connected with a generic track B_{gen} (shown broken). The way points WP and thus the generic track B_{gen} are determined such that the cleaning apparatus 100 detects the entire predefined area A once with the detection area SR at one ride along the generic track B_{gen}. The determining of the way points WP and the generic track B_{gen} is carried out particularly independent of possible dirty objects O1-O4 which have already been detected.

Afterwards, as detected dirty objects O1-O4 have already been detected, these are taken into account and an optimized track Bₒₚₜ (shown as a solid line) is determined. In this example, a first dirty object O1 is within the detection area SR which is therefore already detected. Thus, the cleaning apparatus 100 immediately controls the first dirty object O1. After it has reached this and has successfully picked it up, the cleaning apparatus 100 returns back to the generic track B_{gen} and follows this to a first way point WP. Since in this section no dirty object O1-O4 is arranged, this section of the generic track B_{gen} is also a section of the optimized track Bₒₚₜ. At the way point WP, the cleaning apparatus 100 turns to the right and towards the next way point WP. Shortly thereafter, a second dirty object O2 appears in the detection area SR. Immediately, an optimized track Bₒₚₜ is determined which deviates from the generic track B_{gen}. The optimized track Bₒₚₜ guides the cleaning apparatus 100 over the second dirty object O2 that would have been missed on the generic track B_{gen}, wherein the optimized track Bₒₚₜ is less longer than the generic track B_{gen}.

In this manner, the cleaning apparatus 100 follows the generic track B_{gen} along the way points WP as long as a dirty object O1-O4 appears in the detection area SR, whereupon an optimized track Bₒₚₜ is determined and being driven taking into account the dirty objects O1-O4 detected at a respective time point. In this example, it is apparent that the optimized track Bₒₚₜ is determined from the track planning unit 160 dynamically and each time by taken into account new constraints.

FIG. 5A shows a third embodiment of a cleaning ride along an optimized track Bₒₚₜ. In this example, the entire predefined area A is immediately detected by the cleaning apparatus 100. Thereby, eight dirty objects O1-O8 are detected in sum.

The dirty objects O1 and O6 have a larger distance to further dirty objects O and are taken into consideration as single ones. The dirty objects O2-O5 are located close to each other wherefore they are integrated as one first group G1 of dirty objects O. In the same manner, the dirty objects O7 and O8 are integrated as a second group G2. This is now described in more detail in connection with FIG. 5B.

FIG. 5B shows a second embodiment for a list of dirty object vectors V1-V8 wherein multiple of the dirty object vectors V1-V8 are integrated to group vectors VG1, VG2. In particular, the dirty object vectors V1-V8 represent the situation after the detection and the evaluating of the dirty objects O1-O8 of FIG. 5A. The dirty objects O2-O5 are located very close to each other, wherefore they are integrated into one group vector VG1 instead of four single dirty object vectors V2-V5. This has an area (x₂-x₅, y₂-y₅) instead of a clear position which comprises the positions of the dirty objects O2-O5 represented in the group. Since all of the four dirty objects O2-O5 are assigned to the same dirty class K2, also the group vector VG1 has the dirty class K2. The amounts of the single dirty objects O2-O5 have been added to a total amount such that the group vector VG1 entirely has an amount of 23.

The dirty objects O7 and O8 are also described by a group vector VG2, since they are also located close to each other. Thereby, a specificity is that the group vector VG2 has the dirty class K4, although the dirty object O7 is assigned to the dirty class K3 as can be seen from the dirty object vector V7. In this example, the dirty class K4 is, for example, more specific than the dirty class K3, wherein dirty objects O of the dirty class K3 can be removed with the tools 170 which are employed for handling a dirty object O of the dirty class K4, but not vice versa, for example. Therefore, the dirty class K3 is overwritten at the creation of the group vector VG2. Here, the amount of the group vector VG2 corresponds also to the sum of the single amounts. It is also possible to use different amount masses for different dirty classes K, which optionally can be converted into one another in order to determine the amount of one group vector VG2 comprising the dirty vectors V7, V8 with different dirty classes K.

The track planning unit 160 now determines the optimized track Bₒₚₜ in dependence on the list of dirty object vectors V1-V8, which is shown in FIG. 5, comprising the group vectors VG1, VG2. The first dirty object O1 is not driven to because it is assigned to a dirty class K1 which, for example, has a small priority and has further a small amount of merely 5. Therefore, the track planning unit 160 determines that it is not efficient to drive to the dirty object O1. Instead of that, first the group G1 with the dirty objects O2-O5 is driven to. The dirty objects O2-O5 respectively have the dirty class K2 which has no very high weight. The respective amount of dirty objects O2-O5 is also not very high in itself. However, integrated as group D1 with group vector VG1 the amount is significantly larger, wherefore the first priority increases. Therefore, the optimized track Bₒₚₜ determined by the track planning 160 passes first to the group G1. In the following, the optimized track Bₒₚₜ passes over the dirty object O6 which has a high weight and passes over the group G2 back to the starting point of the cleaning ride.

Alternatively to the shown optimized track Bₒₚₜ, this could be passed in reverse direction and/or could also comprise the dirty object O1. Thereby, it depends on an implementation of the track planning unit 160 and the defaults for optimization which course the optimized track Bₒₚₜ ultimately has.

FIG. 6 shows a fourth embodiment for a cleaning ride along an optimized track Bₒₚₜ. In this embodiment, the detection unit 140 has, amongst others, a decouplable field device 142 and a receiving unit 144. For example, a worker 200 takes the field device 142. The worker 200 moves then along a cleaning corridor RK which sets, for the cleaning apparatus 100, a part area of the predefined area A which is to be cleaned. While the worker 200 moves through the cleaning corridor, he can mark dirty objects O1-O7 by means of the field device 142. In this example, the worker 200 marks the dirty object O4 in particular as a dirty object not to be removed, for example because the cleaning apparatus 100 does not have the tool 170 (see, for example, FIG. 1), required for this, on board.

The cleaning apparatus 100 of this example is exemplary in a part autonomous operation mode. Thereby, the detection of the dirty objects O1-O7 is up to the worker 200. In particular, the worker 200 can not only carry out the position of a dirty object with the field device 142 rather than its classification and/or amount determination and can transmit it from the field device 142 to the receiving unit 144 of the detection unit 140 by means of an information DI. In particular, the information DI is transmitted as a digital data signal and can, for example, have the format of a dirty object vector V. The track planning unit 160 determines an optimized track Bₒₚₜ in dependence on information DI received from the field device 142 and the cleaning corridor RK predefined by the worker 200. Thereby, the cleaning apparatus 100 can also take into account information about the dirty objects O1-O7 detected by means of its internal sensor system 105 and/or the detection unit 140. In this example, the dirty objects O1-O3 are integrated into a group G1, and the dirty objects O5, O6 are integrated into a group G2.

The dirty object O7 is located outside of the cleaning corridor RK, wherefore it is not taken into account at the track planning. The dirty object O4 is excluded from the removal by the worker 200, wherein the cleaning apparatus 100 takes this into account to the extent as the optimized track Bₒₚₜ should avoid the dirty object O4. Hence, the cleaning apparatus 100 firstly controls the group G1 on the optimized track Bₒₚₜ and removes the dirty objects O1-O3. After that, the cleaning apparatus 100 goes to the group G2, wherein the optimized track Bₒₚₜ clearly passes around the dirty object O4.

In this embodiment, the worker 200 has partially controlled the cleaning apparatus 100 in which he has set the cleaning corridor RK for the cleaning apparatus 100 by his movement and in which he has marked dirty objects O1-O6. Nevertheless, the cleaning apparatus 100 determines the optimized track Bₒₚₜ on its own and also in which order and/or with which tool 170 a respective dirty object O1-O6 should be handled.

It can be spoken from a part autonomous operation of the cleaning apparatus. Nevertheless, the operation mode can also be seen as a fully autonomically operating mode at which tough limitations are carried out by the worker 200 in real time, such as the setting of the cleaning corridor RK and the exemption of the dirty object O4 from the cleaning ride.

FIG. 7 shows a schematic block diagram of an embodiment for a method for operating a cleaning apparatus 100, for example of the sweeping machine 100 of FIG. 1.

In a first step S1, dirty objects O arranged in a predefined area A (see FIG. 2, 4, 5A, 6) are detected by a detection unit 140 (see FIG. 1). In a second step S2, each of the detected dirty objects O is classified into a respective dirty class K of a number of different dirty classes K1-K5. In a third step S3, an optimized track Bₒₚₜ is determined in dependence on a respective position P of the detected dirty objects O and the respective dirty class K of the dirty objects O. In a fourth step S4, the control device 130 performs a cleaning ride with the cleaning apparatus 100 along the determined optimized track Bₒₚₜ.

Although the present invention has been described on the basis of embodiments, it can be modified in many ways.

### LIST OF REFERENCE CHARACTERS

100 cleaning apparatus
105 sensor system
110 housing device
120 drive device
130 control device
140 detection unit
142 field device
144 receiving unit
150 evaluation unit
160 track planning unit
170 tool
200 worker
A area
B_{gen} generic track
Bₒₚₜ optimized track
DI information
K dirty class
K1 dirty class
K2 dirty class
K3 dirty class
K4 dirty class
K5 dirty class
M amount
O dirty object
O1 dirty object
O2 dirty object
O3 dirty object
O4 dirty object
O5 dirty object
O6 dirty object
O7 dirty object
O8 dirty object
P position
P1 position
P2 position
P3 position
P4 position
P5 position
P6 position
RK cleaning corridor
SR detection radius
V1 dirty object vector
V2 dirty object vector
V3 dirty object vector
V4 dirty object vector
V5 dirty object vector
V6 dirty object vector
V7 dirty object vector
V8 dirty object vector
VG1 group vector
VG2 group vector
WP way point
x₁ x-position
x₂ x-position
x₃ x-position
x₄ x-position
x₅ x-position
x₆ x-position
x₇ x-position
x₈ x-position
y₁ y-position
y₂ y-position
y₃ y-position
y₄ y-position
y₅ y-position
y₆ y-position
y₇ y-position
y₈ y-position

1. Cleaning apparatus having a housing device for housing dirty objects, a drive device for moving the cleaning apparatus, a control device for controlling the drive device for steering of a movement of the cleaning apparatus in dependence on sensor signals provided by a sensor system, comprising
a detection unit for detecting dirty objects arranged in a predefinable area,
an evaluation unit for classifying the dirty objects detected by the detection unit into different dirty classes, and
a track planning unit for determining an optimized track for the cleaning apparatus in the predefined area in dependence on a respective position of the detected dirty objects and the respective dirty class of the dirty objects,
wherein the control device is configured to control the drive device for performing a cleaning ride along the determined optimized track.

2. Cleaning apparatus according to claim 1,
characterized in
that the detection unit is configured to assign to each detected dirty object a dirty object vector which comprises the position of the detected dirty object, a type of the detected dirty object and/or an amount of the detected dirty object.

3. Cleaning apparatus according to claim 2,
characterized in
that the evaluation unit is configured to classify a detected dirty object in dependence on the assigned dirty object vector.

4. Cleaning apparatus according to claim 1,
characterized in
that the detection unit comprises a field device which can be decoupled from the cleaning apparatus and a receiving unit, wherein the field device is configured for detecting at least one of the dirty objects and for transmitting an indicative information for the detected dirty object to the receiving unit.

5. Cleaning apparatus according to claim 1,
characterized in
that the cleaning apparatus has a plurality of tools for handling dirty objects which is selectively controllable by the control device, wherein a respective tool is optimized for handling dirty objects of a specific dirty class.

6. Cleaning apparatus according to claim 5,
characterized in
that the control device is configured, when the cleaning apparatus reaches a dirty object, to control, in dependence on the dirty class of the reached dirty object, that tool which is optimized for this dirty class for handling the dirty object.

7. Cleaning apparatus according to claim 1,
characterized in
that the track planning unit is configured to dynamically update the optimized track in dependence on time-varying conditions.

8. Cleaning apparatus according to claim 1,
characterized in
that the cleaning apparatus has a verification unit which is configured, after the handling of a dirty object, to determine a success of the handling of the dirty object in dependence on a removal of the dirty object.

9. Cleaning apparatus according to claim 8,
characterized in
that the control device is configured to handle the dirty object again in dependence on the success of the handling.

10. Cleaning apparatus according to claim 1,
characterized in
that the track planning unit is configured to integrate multiple dirty objects into one group of dirty objects and to determine the optimized track in dependence on the group.

11. Cleaning apparatus according to claim 1,
characterized in
that the cleaning apparatus is configured for autonomous cleaning of the predefinable area.

12. Cleaning apparatus according to claim 1,
characterized in
that the cleaning apparatus is a cleaning robot, a road cleaning machine, a sweeping machine or a surface handling machine.

13. Method for operating a cleaning apparatus having a housing device for housing dirty objects, a drive device for moving the cleaning apparatus, a control device for controlling the drive device for steering of a movement of the cleaning apparatus in dependence on sensor signals provided by a sensor system, comprising:
detecting dirty objects arranged in a predefined area by a detection unit,
classifying each detected dirty object into a dirty class of a number of different dirty classes,
determining an optimized track in dependence on a respective position of the detected dirty objects and the respective dirty class of the dirty objects, and
performing a cleaning ride with the cleaning apparatus along the determined optimized track by the control device.

14. Computer program product which initiates the execution of the method according to claim 13 on a program-controlled apparatus.
